(19) United States
(12) Patent Application Publication
(10) Pub. No.: US 2012/0171956 A1
(43) Pub. Date: Jul. 5, 2012

(54) BLUETOOTH SECURITY SYSTEM

(76) Inventor: Cheng-En Lee, Tucheng City (TW)

(21) Appl. No.: 12/984,601

(22) Filed: Jan. 4, 2011

(51) Int. Cl. G08B 7/00; H04B 7/00

(52) U.S. Cl. 455/41.2

(57) ABSTRACT

A Bluetooth security system includes a master unit and a slave unit for matched connection by means of Bluetooth technology, an inquiry procedure adapted for monitoring the connection signal between the master unit and the slave unit, and an alarm device installed in each of the master unit and the slave unit and adapted for receiving a feedback signal from the inquiry procedure to output an alert message when the strength of the connection signal between the master unit and the slave unit drops below a predetermined threshold.

### BACKGROUND OF THE INVENTION

(a) Field of the Invention

The present invention relates to security technology and more specifically to a Bluetooth security system design, which triggers an alarm device to output an alert message when the strength of the connection signal between the master unit and the matched slave unit drops below a predetermined threshold.

(b) Description of the Prior Art

Bluetooth is a proprietary open wireless technology standard for short-distance wireless communication between two devices, creating personal area networks with high security. Following the development of communication technology, many mobile electronic devices, such as cell phone, PDA, laptop, MP3 or the like are equipped with Bluetooth communication technology for short-distance wireless communication. Within the personal area network created thereby, broadband message transmission is free and secure. Many types of mobile peripheral apparatus have been created and have appeared on the market (such as Bluetooth earphone, Bluetooth microphone, Bluetooth keyboard, Bluetooth mouse).

However, in the application of this convenient technology, due to wireless communication, the two matched devices may be separated over the effective communication distance, causing interruption of signal connection. When this happens, the user must restart the connection. Further, because the two matched devices are not connected with a cable, the user may forget to pick up the other device when carrying one device away from a place. U.S. 2006/0199534 A1 teaches a method and system for tracking and locating Bluetooth devices. This technique is adapted for enabling the parents to monitor and search a child but not designed for the purpose of preventing missing of a personal device. Taiwan Utility Model 096210457 discloses a Bluetooth alarm device, which is adapted for triggering an alarm unit when the distance between the Bluetooth module and the Bluetooth mobile device surpasses a predetermined value. As the critical distance is too long, this design cannot prevent problems before they happen.

In view of the aforesaid problems, it is desirable to provide a design, which enables two Bluetooth matched wireless devices to be effectively traced, and provides an alert message when the critical distance is reached before signal disconnection, thereby effectively preventing problems before they happen.

### SUMMARY OF THE INVENTION

The present invention has been accomplished under the circumstances in view. It is one object of the present invention to provide a Bluetooth security system, which triggers an alarm device to output an alert message when the strength of the connection signal between the master unit and the matched slave unit drops below a predetermined threshold.

To achieve this and other objects of the present invention, a Bluetooth security system comprises a master unit having set therein a Bluetooth RF module, a slave unit having set therein a Bluetooth RF module, an inquiry procedure adapted for monitoring connection signal between the master unit and the slave unit, and an alarm device installed in each of the master unit and the slave unit and adapted for receiving a feedback signal from the inquiry procedure. The inquiry procedure is respectively written into the master unit and the slave unit to monitor the connection signal between the Bluetooth RF module in the master unit and the Bluetooth RF module in the slave unit and to provide a feedback signal for trigging the associated alarm device when the strength of the connection signal drops below a predetermined threshold.

Further, the alarm device can be a visual alarm device adapted for giving off a visual alert message through the display screen of the master unit or the slave unit. Alternatively, the alarm device can be an audio alarm device adapted for providing an audio alert message or a vibration alarm device adapted for providing a vibration alert message.

Further, the inquiry procedure can set the maximum number of times that the operation loop of the associated alarm device can be triggered and its response frequency.

Further, according to the application of the Bluetooth security system of the present invention, the two matched devices in connection will output an alert message upon separation over a predetermined distance, thus preventing interruption of signal connection.

### BRIEF DESCRIPTION OF THE DRAWINGS

FIG. 1 is a schematic drawing illustrating the structural arrangement of the Bluetooth security system in accordance with the present invention.

FIG. 2 is an operation flow chart of the Bluetooth security system in accordance with the present invention.

FIG. 3 is a schematic drawing illustrating an application example of the Bluetooth security system in accordance with the present invention.

### DETAILED DESCRIPTION OF THE PREFERRED EMBODIMENTS

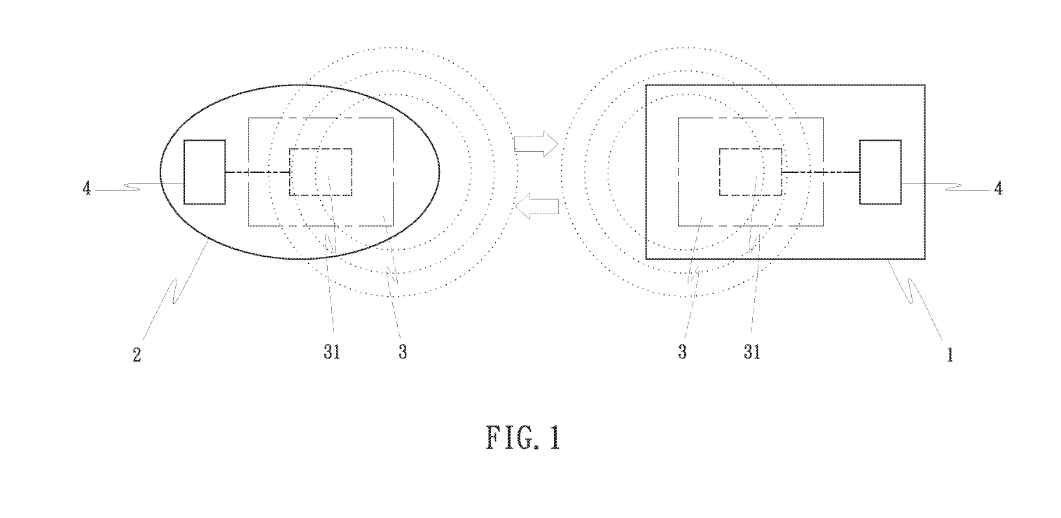

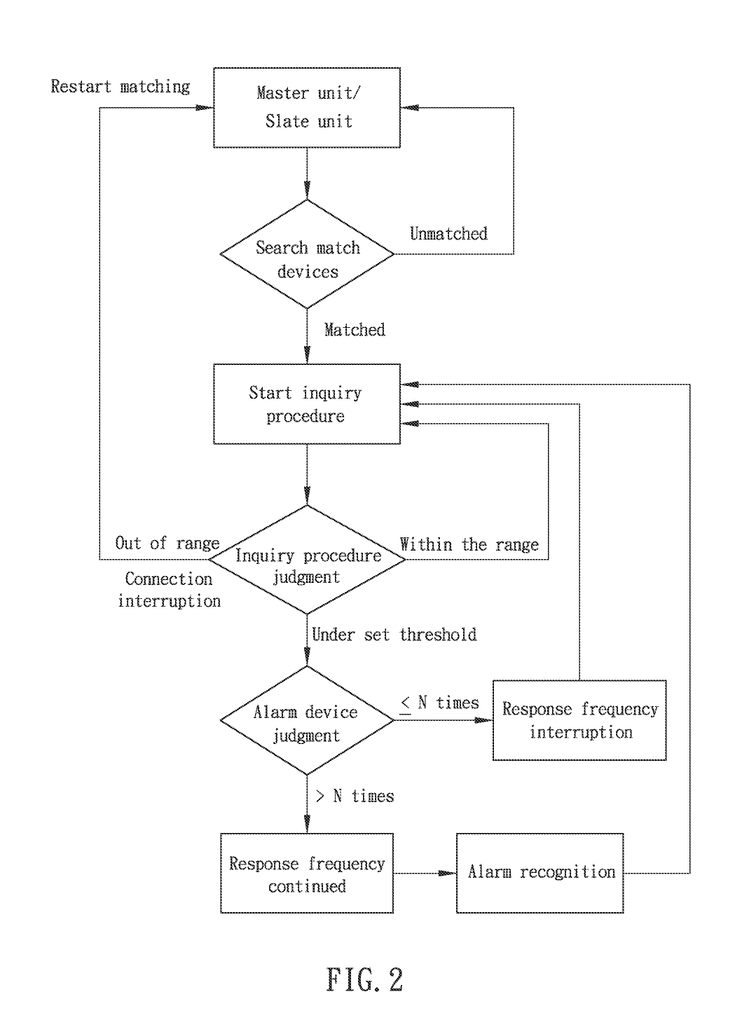

As shown in FIGS. 1 and 2, a Bluetooth security system in accordance with the present invention comprises a master unit 1, a slave unit 2, an RF module 3 prepared according to Bluetooth protocol and installed in each of the master unit 1 and the slave unit 2, and an alarm device 4 installed in each of the master unit 1 and the slave unit 2. The RF module 3 has coded therein an inquiry procedure 31 for monitoring the connection signal between the master unit 1 and the slave unit 2 and for trigging the associated alarm device 4 based on the strength of the sensed connection signal.

In operation, the slave unit 2 continuously transmits a signal through the respective RF module 3 to stay in connection with the master unit 1. At the same time, the inquiry procedure 31 in the master unit 1 and the inquiry procedure 31 in the slave unit 2 synchronously monitor the connection signal between the master unit 1 and the slave unit 2. When the strength of the sensed connection signal drops below a predetermined threshold, the inquiry procedure 31 feeds back a signal to trigger the associated alarm device 4, and then the alarm device 4 in the master unit 1 and the alarm device 4 in the slave unit 2 are synchronously driven to output an alert message.

Further, the operation logic of the inquiry procedure 31 is coded into the associated RF module 3 so that the inquiry procedure 31 determines whether to trigger the associated alarm device 4 based on the strength of the connection signal received. The inquiry procedure 31 can set a signal strength threshold. If the strength of the connection signal received is over the set signal strength threshold, the inquiry procedure 31 keeps monitoring the connection signal without triggering the associated alarm device 4. If the strength of the connection signal received drops below the set signal strength threshold, the inquiry procedure 31 provides a feedback signal to trigger the associated alarm device 4, causing the associated alarm device 4 to output an alert message in the form of a visual light, a sound or a vibration. Further, the inquiry procedure 31 can set the maximum number of times that the operation loop of the associated alarm device 4 can be triggered and its response frequency.

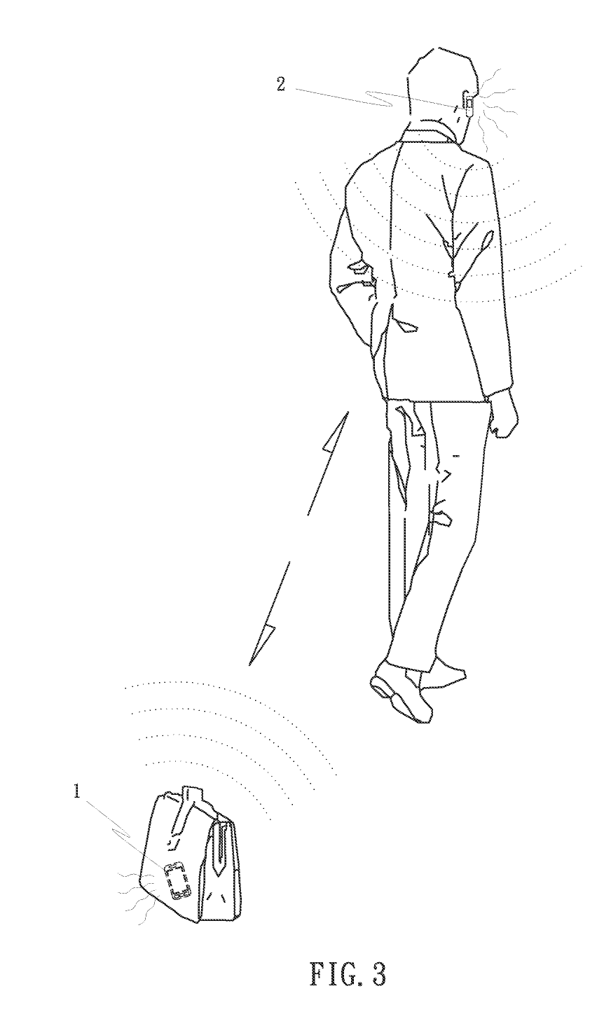

According to the operation principle of the Bluetooth security system of the present invention, the master unit 1 and the slave unit 2 can be applied to a Bluetooth cell phone and a Bluetooth earphone. As illustrated in the application example of FIG. 3, if the user is simply carrying either the Bluetooth cell phone (the master unit 1) or the Bluetooth earphone (the slave unit 2) without picking up the other device after the connection signal between the Bluetooth cell phone (the master unit 1) and the Bluetooth earphone (the slave unit 2), the alarm device 4 in each of the Bluetooth cell phone (the master unit 1) and the Bluetooth earphone (the slave unit 2) will be triggered to output an alert message immediately when the Bluetooth cell phone (the master unit 1) and the Bluetooth earphone (the slave unit 2) is separated over a predetermined distance, advising the user not to forget the other device. The alert message can be selectively outputted through the display screen, indicator light, speaker or vibrator of the Bluetooth cell phone (the master unit 1) or Bluetooth earphone (the slave unit 2). According to the application of the present invention, the possibility of missing the Bluetooth cell phone is minimized, and the effective communication connection between the Bluetooth cell phone and the Bluetooth earphone is assured.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A Bluetooth security system, comprising:
a master unit having set therein a Bluetooth RF module;
a slave unit having set therein a Bluetooth RF module;
an inquiry procedure adapted for monitoring connection signal between said master unit and said slave unit; and
an alarm device installed in each of said master unit and said slave unit and adapted for receiving a feedback signal from said inquiry procedure;
wherein said inquiry procedure is respectively coded into said master unit and said slave unit to monitor a connection signal between the Bluetooth RF module in said master unit and the Bluetooth RF module in said slave unit and to provide a feedback signal for trigging the associated alarm device when the strength of said connection signal drops below a predetermined threshold.

2. The Bluetooth security system as claimed in claim 1, wherein said alarm device is a visual alarm device adapted for giving off a visual alert message.

3. The Bluetooth security system as claimed in claim 2, wherein said visual alarm device is adapted for giving off a visual alert message through a display screen of said master unit.

4. The Bluetooth security system as claimed in claim 2, wherein said visual alarm device is adapted for giving off a visual alert message through a display screen of said slave unit.

5. The Bluetooth security system as claimed in claim 1, wherein said alarm device is an audio alarm device adapted for providing an audio alert message.

6. The Bluetooth security system as claimed in claim 1, wherein said alarm device is a vibration alarm device adapted for providing a vibration alert message.
